(19) United States
(12) Patent Application Publication
(10) Pub. No.: US 2010/0202762 A1
(43) Pub. Date: Aug. 12, 2010

(54) SIGNAL PROCESSING APPARATUS, SIGNAL PROCESSING METHOD AND REPRODUCING APPARATUS

(75) Inventor: Shoichi OSHIMA, Nishitokyo-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/625,273

(22) Filed: Nov. 24, 2009

(30) Foreign Application Priority Data
Feb. 12, 2009 (JP) 2009-030110

(51) Int. Cl. H04N 5/91; H04L 27/00; H04L 7/00

(52) U.S. Cl. 386/124; 375/259; 375/354; 386/E05.003

(57) ABSTRACT

According to one embodiment, an information processing apparatus includes an encoding module, a decoding module, and a controller which controls operations of the encoding module and the decoding module. The encoding module includes a first arithmetic module which subjects data to an encoding process by using a first apparatus unique value, and a transmission module which outputs the data that is encoded. The decoding module includes a reception module which receives the encoded data that is output from the encoding module, and a second arithmetic module which decodes the encoded data by using a second apparatus unique value. The first apparatus unique value and the second apparatus unique value are the same value that is shared by the encoding module and the decoding module.

### CROSS-REFERENCE TO RELATED APPLICATIONS

This application is based upon and claims the benefit of priority from Japanese Patent Application No. 2009-030110, filed Feb. 12, 2009, the entire contents of which are incorporated herein by reference.

### BACKGROUND

1. Field

One embodiment of the present invention relates to a signal processing apparatus, a signal processing method and a reproducing apparatus.

2. Description of the Related Art

When data, which is protected by a protection standard, is decoded and reproduced by an information processing apparatus, there are cases in which non-compressed and non-encrypted data is present in a signal processing path for decoding and reproducing data which is protected by the protection standard. In such cases, there is a concern of unlawful copy, tampering or tapping of the data that is to be protected.

Conventionally, there has been proposed, for instance, an apparatus wherein functions (a tuner, a descrambler, an MPEG decoder, and a display output unit for display output to a display unit) for processing secret data are structured on a PCI device of the same circuit, so that the secret data may not be output to a PCI bus that is a common bus in the apparatus (see, for instance, Jpn. Pat. Appln. KOKAI Publication No. 2002-222119).

In addition, when data, which is protected by a protection standard, is decoded and reproduced, there is a case where non-compressed and non-encrypted data is present in a signal processing path for decoding, reproducing and recording data which is protected by the protection standard. In this case, in order to prevent unlawful copy, tampering or tapping of data, use has been made of an LSI (large-scale integration) of a BGA (Ball Grid Array) package, or a wiring pattern is disposed in an inner layer of the substrate, or the system is implemented in an LSI.

However, in the case where the processing system is implemented in the LSI, as described above, in order to prevent unlawful copy, tampering or tapping of data, it is difficult to make use of a signal in a signal processing process, and, in some cases, the degree of freedom of the system is restricted.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a view for describing an exemplary structure example of a signal processing apparatus according to an embodiment of the present invention;

FIG. 2 is a view for describing an exemplary structure example of an encoding module of the signal processing apparatus shown in FIG. 1;

FIG. 3 is a view for describing an exemplary structure example of a decoding module of the signal processing apparatus shown in FIG. 1; and

FIG. 4 is a flow chart illustrating an example of an exemplary signal processing method according to the embodiment of the invention.

### DETAILED DESCRIPTION

Various embodiments according to the invention will be described hereinafter with reference to the accompanying drawings. In general, according to one embodiment of the invention, there is provided an information processing apparatus comprising an encoding module, a decoding module, and a controller configured to control operations of the encoding module and the decoding module, wherein the encoding module includes a first arithmetic module configured to subject data to an encoding process by using a first apparatus unique value, and a transmission module configured to output the data that is encoded, the decoding module includes a reception module configured to receive the encoded data that is output from the encoding module, and a second arithmetic module configured to decode the encoded data by using a second apparatus unique value, and the first apparatus unique value and the second apparatus unique value are the same value that is shared by the encoding module and the decoding module.

A signal processing apparatus, a signal processing method and a reproducing apparatus according to an embodiment of the present invention will now be described. The signal processing apparatus and signal processing method according to the embodiment relate, for example, to transmission of data, which is protected according to a protection standard, in a video reproducing apparatus. The apparatus includes an encoding module 1, which encodes non-compressed and non-encrypted data into secret data by an apparatus unique value, and a decoding module 2, which receives the secret data from the encoding module 1 and decodes the secret data by the same value as the apparatus unique value that is used in the encoding module 1, in a signal processing path of a signal which is output from a signal processing module (not shown) which executes a signal process for decoding and reproducing the secret data that is received by a reception module (not shown).

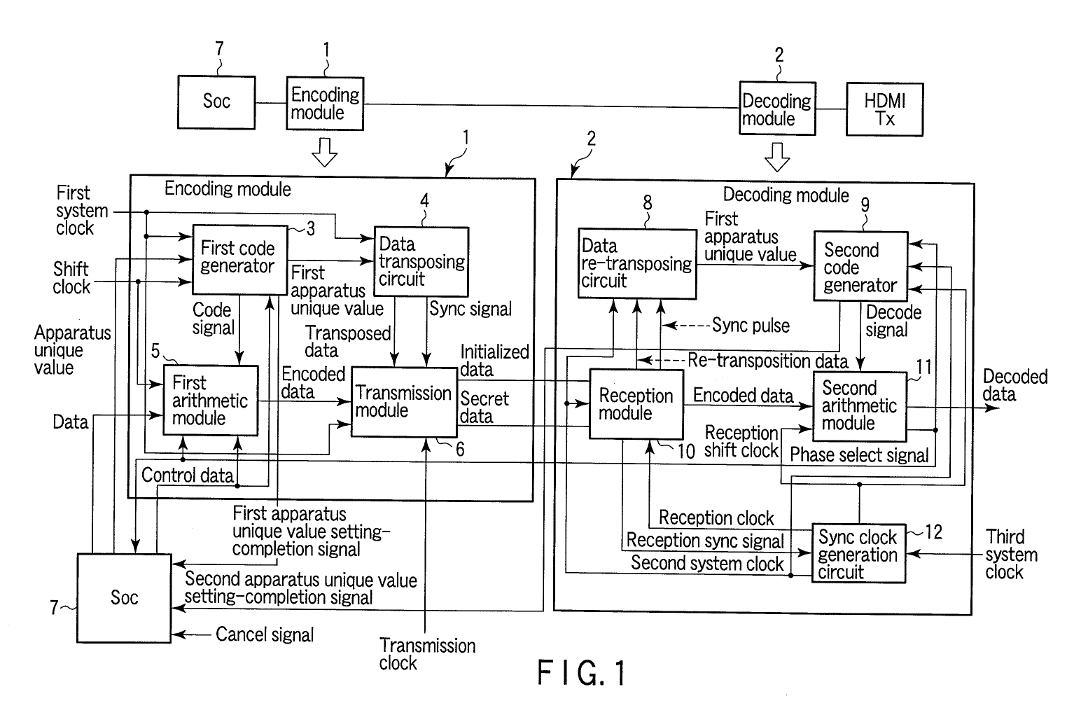

Specifically, as shown in FIG. 1, the signal processing apparatus according to the present embodiment includes an encoding module 1, a decoding module 2, and an SoC (System on Chip) 7 functioning as a controller for controlling the operations of the encoding module 1 and decoding module 2. Decoded data, which is output from the decoding module 2, is supplied to a display or a speaker, with use of an interface such as an HDMI (High Definition Multimedia Interface).

The encoding module 1 includes a first code generator 3, a data transposing circuit 4, a first arithmetic module 5 and a transmission module 5. The decoding module 2 includes a data re-transposing circuit 8, a second code generator 9, a reception module 10, a second arithmetic module 11 and a sync clock generation circuit 12.

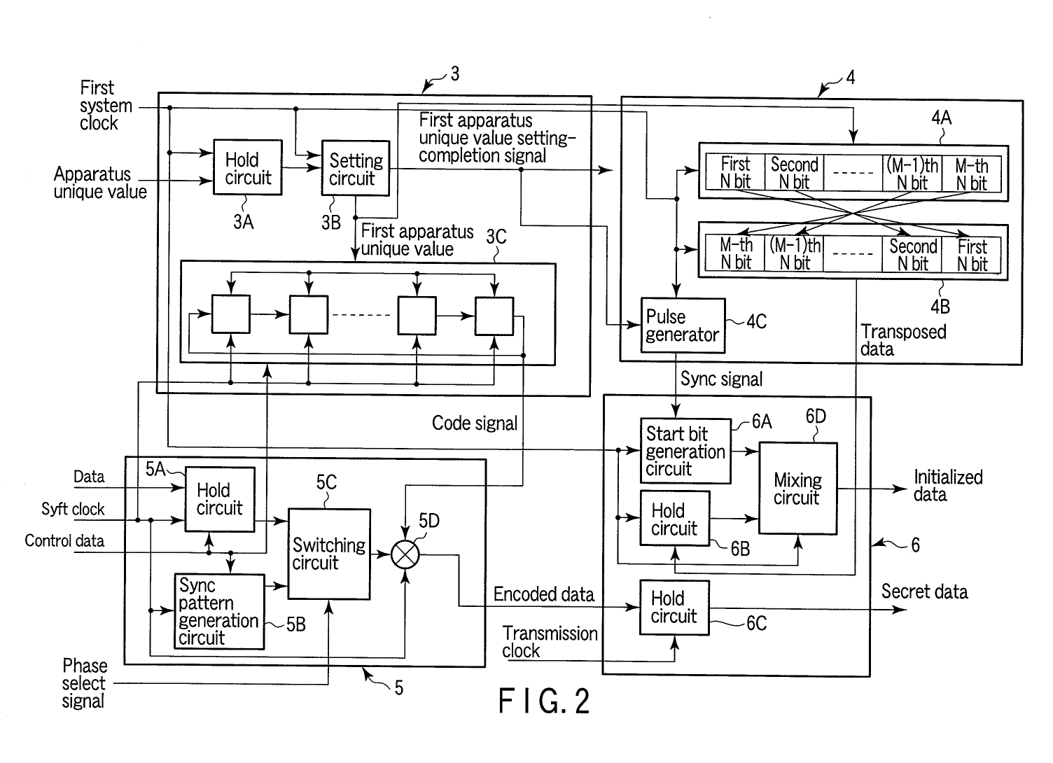

As is shown in FIG. 1 and FIG. 2, data to be protected and an apparatus unique value are supplied from the SoC 7 to the encoding module 1. The first code generator 3 includes a hold circuit 3A which holds the apparatus unique value that is supplied from the SoC 7; a setting circuit 3B which sets the apparatus unique value as a first apparatus unique value; and a shift register module 3C which shifts the first apparatus unique value, after set in the setting circuit 3B, at a predetermined timing.

The first code generator 3 holds the apparatus unique value from the SoC 7 in the hold circuit 3A, and outputs, from the setting circuit 3B, the first apparatus unique value and a first apparatus unique value setting-completion signal. The first apparatus unique value is set in the shift register 3C. In accordance with a shift clock, the value of the first apparatus unique value shifts in the shift register module 3C. The apparatus unique value that is supplied to the first code generator 3 may be a value which is preset in the apparatus, or a value which is obtained by processing the value that is preset in the apparatus.

The apparatus unique value, which is received by the first code generator 3, is output as the first apparatus unique value from the first code generator 3. In order to share the first apparatus unique value between the encoding module 1 and the decoding module 2, the first apparatus unique value is transmitted from the encoding module 1 to the decoding module 2.

At this time, if the first apparatus unique value, which is not encrypted, is transmitted from the encoding module 1 to the decoding module 2, it is possible that the first apparatus unique value is exposed. Thus, the data transposing circuit 4 outputs transposed data, in which the sequence of the first apparatus unique value is transposed and varied, and a sync signal which is used as a start pulse. The apparatus unique value is encoded with a cycle which corresponds to an integer-number of times of the frequency of the data that is supplied from the SoC 7 to the encoding module 1.

As shown in FIG. 2, the data transposing circuit 4 includes a first hold circuit 4A and a second hold circuit 4B for transposing the first apparatus unique value that is supplied from the first code generator 3; and a pulse generator 4C which generates a sync signal.

The first apparatus unique value, which is output from the first code generator 3, is supplied to the first hold circuit 4A. The first hold circuit 4A holds the first apparatus unique value. When the first hold circuit 4A outputs the first apparatus unique value to the second hold circuit 4B, the first hold circuit 4A sequentially transposes the first apparatus unique value in units of N bit so that the last bit of the first apparatus unique value may come to the first bit. The second hold circuit 4B outputs the data, which has been transposed such that the last bit of the first apparatus unique value comes to the first bit, to the transmission module 6 as transposed data. On the other hand, upon receiving the first apparatus unique value setting-completion signal, the pulse generator 4C outputs the sync signal to the transmission module 6 with use of a first system clock.

As shown in FIG. 2, the transmission module 6 includes a start bit generation circuit 6A which is supplied with the sync signal; a hold circuit 6B which is supplied with the transposed data; and a mixing circuit 6D which is supplied with an output signal from the start bit generation circuit 6A and an output signal from the hold circuit 6B. The transmission module 6 outputs to the decoding module 2 initialized data including the sync signal and transposed data which are supplied from the data transposing circuit 4.

The start bit generating circuit 6A receives the sync signal with use of the first system clock, and outputs the sync signal to the mixing circuit 6D. The hold circuit 6B holds the transposed data, and outputs the transposed data to the mixing circuit 6D. The mixing circuit 6D mixes the sync signal which is supplied from the start bit generation circuit 6A, and the transposed data which is supplied from the hold circuit 6B, and outputs the resultant data as initialized data. After a phase select signal (to be described later) is output, a hold circuit 6C receives encoded data with use of a transmission clock, and outputs the encoded data as secret data by using the transmission clock.

On the other hand, in order to prevent the first apparatus unique value from being set once again in a case where a duplicating circuit is fabricated outside, the setting circuit 3B of the first code generator 3 outputs, at a timing when the first apparatus unique value is once set, the first apparatus unique value setting-completion signal, which is indicative of the completion of setting, to the SoC 7. The SoC 7 holds the first apparatus unique value setting-completion signal.

The SoC 7 detects, from the first apparatus unique value setting-completion signal, that the setting of the apparatus unique value has been executed in the encoding module 1, and does not execute re-setting of the apparatus unique value unless a cancel signal is input. By the operations thus far, the setting of the first apparatus unique value in the encoding module 1 and the setting of the illegality prevention function are completed.

The first apparatus unique value setting-completion signal is also supplied to the pulse generator 4C. The pulse generator 4C detects, from the first apparatus unique value setting-completion signal, that the setting of the apparatus unique value has been executed, and outputs the sync signal for executing the signal processing by the first apparatus unique value.

Next, the operation for encoding the data that is supplied from the SoC 7 is described. The data is supplied from the SoC 7 to the first arithmetic module 5. As shown in FIG. 2, the first arithmetic module 5 includes a hold circuit 5A which is supplied with a shift clock and the data; a sync pattern generation circuit 5B which is supplied with the shift clock; a switching circuit 5C which is supplied with output signals from the hold circuit 5A and sync pattern generation circuit 5B; and an arithmetic device 5D which is supplied with an output signal from the switching circuit 5C, the shift clock, and a code signal which is output from the first code generator 3. Specifically, the first arithmetic module 5 and the shift register module 3C operate in synchronism by the shift clock.

To begin with, in the first arithmetic module 5, prior to data encoding, the sync pattern generation circuit 5B of the first arithmetic module 5 generates a sync pattern, and the sync pattern is encoded by the first apparatus unique value and is output to the transmission module 6 as encoded data. The transmission module 6 holds the supplied encoded data, and outputs it as secret data to the decoding module 2.

Specifically, before the first arithmetic module 5 receives the phase select signal, the switching circuit 5C is controlled by a control signal from the SoC 7 so as to output the sync pattern from the sync pattern generation circuit 5B that operates by the shift clock. The sync pattern is encoded by the code signal in the arithmetic device 5D, and is output to the transmission module 6 as encoded data. The arithmetic device 5D executes a spreading process by multiplying the sync pattern by the code signal, and sets the sync pattern in a secret state.

If the decoding module 2 outputs the phase select signal (to be described later) to the first code generator 3, first arithmetic module 5 and SoC 7, the first arithmetic module 5 stops the encoding of the sync pattern by the phase select signal, and prepares to encode data. As shown in FIG. 2, the phase select signal is supplied to the switching circuit 5C of the first arithmetic module 5, and the switching circuit detects the phase select signal and switches the signal that is to be output.

Upon detecting the phase select signal, the SoC 7 outputs control data to the first code generator 3 and first arithmetic module 5. The first arithmetic module 5 receives, by the control data, the shift clock by using the data that is output from the SoC 7. The first code generator 3 outputs, by the control data, the code data by using the shift clock.

The received data is subjected to an arithmetic operation in the arithmetic device 5D of the first arithmetic module 5 by the code signal that is generated from the first code generator 3 by using the first apparatus unique value, and the resultant data is output to the transmission module 6 as encoded data. The encoded data is supplied to the hold circuit 6C of the transmission module 6. In sync with the transmission clock, the hold circuit 6C outputs the encoded data as secret data to the decoding module 2.

Specifically, after the first arithmetic module 5 has received the phase select signal, the switching circuit 5C is controlled so as to output the data that is supplied from the hold circuit 5A. The data that is output from the switching circuit 5C is encoded by the code signal in the arithmetic device 5D, and is output as encoded data to the transmission module 6. The arithmetic device 5D executes a spreading process by multiplying the data by the code signal, and sets the data in a secret state.

By subjecting the data to the spreading process with use of the first apparatus unique value and encoding the data, as described above, the data can be set in the secret state, and the power at the time of data transmission can be decreased.

In the signal processing apparatus according to the present embodiment, as regards the clock that is used in the encoding module 1, the first system clock is used when the first code generator 3 executes the reception of the apparatus unique value from the SoC 7 and the transmission of the first apparatus unique value.

The shift clock is used when the first code generator 3 generates the code signal, and the first system clock is used when the data transposing circuit 4 executes the reception of the first apparatus unique value, the transmission of the transposed data, and the transmission of the sync signal.

The first arithmetic module 5 uses the shift clock for the reception of the data and the transmission of the encoded data. The transmission module 6 uses the first system clock for the reception of the transposed data, the reception of the sync signal and the transmission of the initialized data, and uses the transmission clock for the reception of the encoded data and the transmission of the secret data. It is assumed that the first system clock, shift clock and transmission clock, which are used in the above-described operations, are synchronized.

Next, the operation of the decoding module 2 is described. The initialized data and secret data, which are output from the encoding module 1, are supplied to the reception module 10 of the decoding module 2. In the decoding module 2, if the initialized data from the encoding module 1 is received by the reception module 10 by using the second system clock, the initialized data is separated into a reception sync signal, a sync pulse, and re-transposition data.

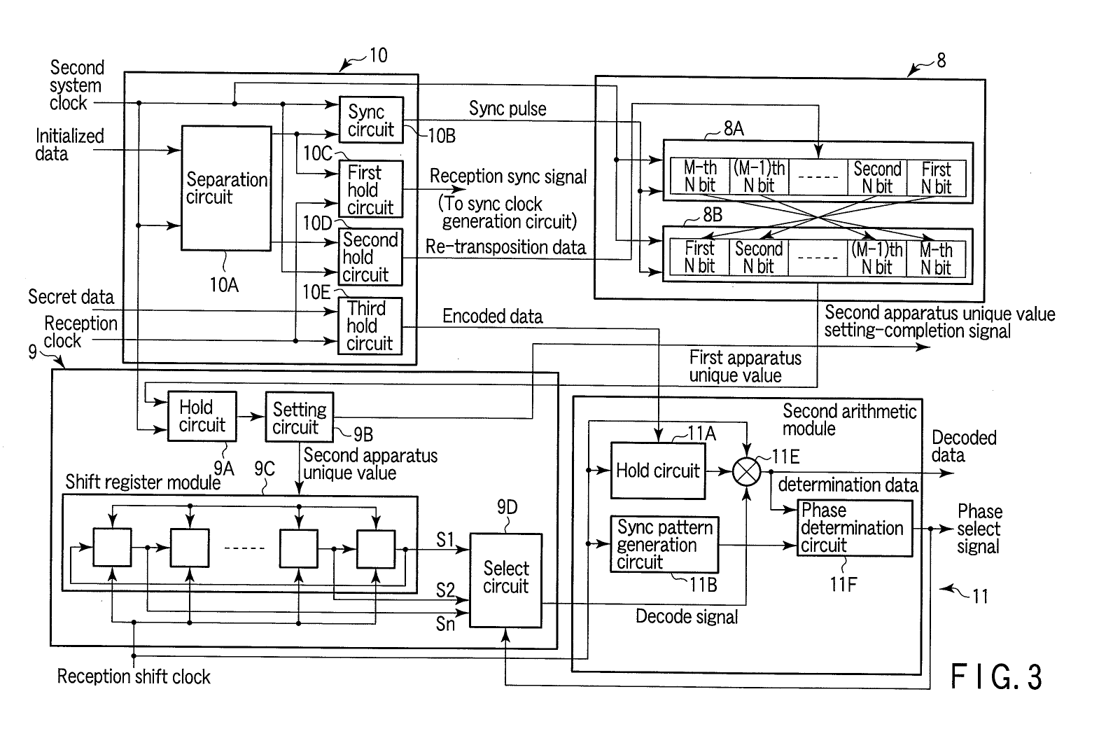

Specifically, as shown in FIG. 3, the reception module 10 includes a separation circuit 10A which is supplied with the initialized data, and a sync circuit 10B, a first hold circuit 10C and a second hold circuit 10C, which are supplied with the signals that are separated by the separation circuit 10A.

In the reception module 10, the separation circuit 10A, which operates with the second system clock, receives the initialized data. The separation circuit 10A separates the initialized data, which has been mixed in the transmission module 6, into the sync signal and transposed signal.

The sync signal is received by the sync circuit 10B, second hold circuit 10D and first hold circuit 10C. The sync circuit 10B and second hold circuit 10D operate with use of the second system clock. The first hold circuit 10C operates with use of a reception clock.

The sync circuit 10B outputs the sync signal as a sync pulse to the data re-transposing circuit 8. The first hold circuit 10C outputs the sync signal as a reception sync signal to the sync clock generation circuit 12. The sync clock generation circuit 12 operates with use of a third system clock. The sync clock generation circuit 12 outputs the second system clock, the reception clock and a reception shift clock, which are in sync with the reception sync signal.

The second system clock is supplied to the data re-transposing circuit 8 and reception module 10. The reception clock is supplied to the reception module 10. The reception shift clock is supplied to the second code generator 9 and second arithmetic module 11.

Specifically, by transmitting the sync signal, which is not encoded, from the encoding module 1 to the decoding module 2, the operations of the encoding module 1 and decoding module 2 can be synchronized, and the signal that is supplied from the encoding module 1 can be received by the decoding module 2. The sync signal, which is output from the encoding module 1, is used as a start pulse of the decoding module 2.

The second hold circuit 10D outputs the transposed data as re-transposition data to the data re-transposing circuit 8. On the other hand, the secret data is held in a third hold circuit 10E which operates with the reception clock, and is output as encoded data to the second arithmetic module 11.

The data re-transposing circuit 8 reproduces the first apparatus unique value from the supplied re-transposition data and the sync pulse. As shown in FIG. 3, the data re-transposing circuit 8 includes a first hold circuit 8A and a second hold circuit 8B. The first hold circuit 8A is supplied with the re-transposition data. The re-transposition data is supplied to the second hold circuit 8B such that the re-transposition data is transposed in units of N bit.

Specifically, the data re-transposing circuit 8 operates with the second system clock, and executes a re-transposing process by using the same algorithm as in the transposing method in the process of the data transposing circuit 4 of the encoding module 1. Since the data transposing circuit 4 has executed transposition by the reversal of the bit sequence, the data re-transposing circuit 8 executes, once again, the bit sequence reversing process by using the sync pulse, thereby restoring the sequence of the re-transposition data to the original sequence, and outputting the resultant data as the first apparatus unique value.

The first apparatus unique value, which is output from the data re-transposing circuit 8, is supplied to the second code generator 9 by using the second system clock. As shown in FIG. 3, the second code generator 9 includes a hold circuit 9A which is supplied with the first apparatus unique value; a setting circuit 9B which is supplied with the first apparatus unique value that is output from the hold circuit 9A; a shift register module 9C which is supplied with a second apparatus unique value which is output from the setting circuit 9B; and a select circuit 9D which is supplied with signals S1, S2, . . . , Sn, which are output from the shift register module 9C.

The first apparatus unique value, which is output from the data re-transposing circuit 8, is supplied to the hold circuit 9A which operates with the second system clock. The hold circuit 9A supplies, by the second system clock, the first apparatus unique value to the setting circuit 9B. The setting circuit 9B sets the first apparatus unique value as a second apparatus unique value, and outputs the second apparatus unique value and a second apparatus unique value setting-completion signal. By the above-described operation, the encoding module 1 and decoding module 2 can securely share the same apparatus unique value.

As has been described in connection with the encoding module 1, there is provided the scheme for preventing the apparatus unique value from being set once again in a case where a duplicating circuit is fabricated outside. According to this scheme, if the second apparatus unique value is set in the second code generator 9 of the decoding module 2, the second apparatus unique value setting-completion signal is output from the setting circuit 9B to the SoC 7.

The SoC 7 detects, from the first apparatus unique value setting-completion signal and the second apparatus unique value setting-completion signal, that the setting of the apparatus unique value has been executed in the encoding module 1 and the decoding module 2, and does not execute re-setting of the apparatus unique value unless a cancel signal is input. By the operations thus far, the setting of the apparatus unique value in the encoding module 1 and decoding module 2 and the setting of the illegality prevention function are completed.

The second apparatus unique value, which is output from the setting circuit 9B, is set in the shift register module 9C, and the value of the second apparatus unique value shifts in the shift register module 9C by the reception shift clock. The respective phases of the shift register module 9C are output to the select circuit 9D as phase signals S1, S2, . . . , Sn. The select circuit 9D outputs a decode signal by setting the phase signal S1 as an initial phase, until the phase information of the select circuit 9D is set by the phase select signal.

After the phase select signal is output, the select circuit 9D selects the phase from the phase signals S1, S2, . . . , Sn, on the basis of the phase information of the phase select signal, and outputs the selected phase as a decoded signal. The phase signal S1, S2, . . . , Sn, which is selected by the phase information, is determined by the bit number of the second apparatus unique value.

Next, a decoding operation of the secret data is described. The secret data is held in the third hold circuit 10E of the reception module 10, with use of the reception clock, and is output as encoded data to the second arithmetic module 11. The secret data is a signal which is generated by encoding the sync pattern, until the phase select signal is output from the second arithmetic module 11.

Since the sync pattern is encoded by the first apparatus unique value, the sync pattern is decoded by the first apparatus unique value in the second arithmetic module 11. The second arithmetic module 11 includes a hold circuit 11A which is supplied with the encoded data from the third hold circuit 10E; a sync pattern generation circuit 11B which generates a sync pattern from the reception shift clock; an arithmetic device 11E which decodes the encoded data, which is output from the hold circuit 11A, by using the decode signal which is supplied from the select circuit 9D; and a phase determination circuit 11F which detects the phase of the decode signal by using the sync pattern.

The second arithmetic module 11 operates with the reception shift clock. The sync pattern generation circuit 11B generates the same sync pattern as the sync pattern that is generated by the encoding module 1 by using the reception shift clock. The sync pattern, which is output from the sync pattern generation circuit 11B, is output to the phase determination circuit 11F.

The encoded data, which is held in the hold circuit 11A, is subjected to an arithmetic operation in the arithmetic device 11E with the decode signal from the second code generator 9. At this stage, the encoded data that is held in the hold circuit 11A is the data that is generated by encoding the sync pattern which is generated by the sync pattern generation circuit 5B of the first arithmetic module 5. The arithmetic result in the arithmetic device 11E is output as determination data to the phase determination circuit 11F, and is subjected to phase determination with the sync pattern that is output from the sync pattern generation circuit 11B.

If the phase determination in the phase determination circuit 11F is completed, the phase information is output from the phase determination circuit 11F as the phase select signal to the select circuit 9D of second code generator 9, the first arithmetic module 5 and the SoC 7. If the phase select signal is output, the secret data as the encoded data is output from the reception module 10. Thus, the secret data (encoded data) and the decode signal are subjected to an arithmetic operation in the arithmetic module 11E, and decoded data can be obtained.

Specifically, the decoding of the secret data is performed in the following manner. After the phase select signal is output from the phase determination circuit 11F of the second arithmetic module 11, the select circuit 9D selects the phase from the phase signals S1, S2, . . . , Sn, on the basis of the phase information of the phase select signal, and outputs the selected phase as the decode signal. The decode signal and the encoded data are subjected to the arithmetic operation. The decoded data, which has thus been obtained, is the same data as the data to be protected, which has been supplied from the SoC 7 to the encoding module 1.

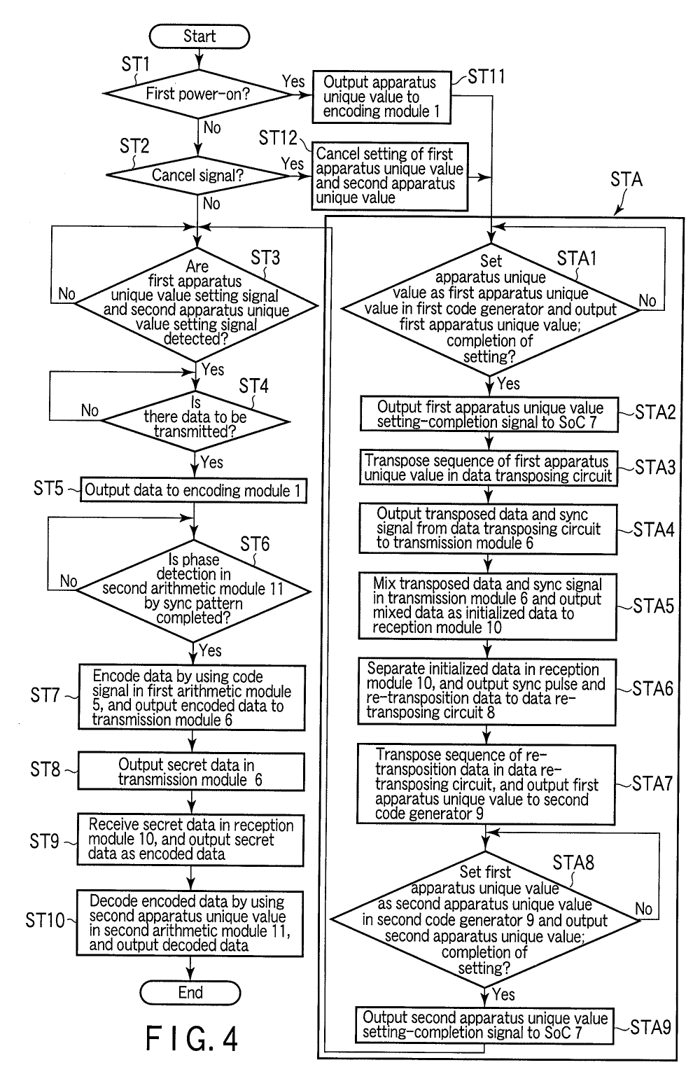

Next, referring to the drawings, a description is given of the signal processing method according to the embodiment of the invention. As illustrated in FIG. 4, when power is turned on, it is determined whether the power-on is the first one or not (block ST1). The first power-on is power-on which is first executed after the apparatus is initialized.

If the power-on is not the first power-on, it is then determined whether the cancel signal has been transmitted or not (block ST2). If the cancel signal has not been transmitted, it is determined whether the first apparatus unique value setting-completion signal and the second apparatus unique value setting-completion signal are detected or not (block ST3). If these signals are detected, the SoC 7 determines the presence/absence of data that is to be transmitted (block ST4). If there is data to be transmitted, the data to be transmitted is sent to the encoding module 1 (block ST5).

If second or following power-on is executed, the second arithmetic module 11 first executes the phase detection by the sync pattern. If the phase detection is executed (block ST6), the first arithmetic module 5 executes the process of encoding the data by using the code signal that is obtained by the first apparatus unique value, and outputs the encoded data to the transmission module 6 (block ST7). The transmission module 6 outputs the encoded data as secret data to the decoding module 2 (block ST8).

The reception module 10 receives the secret data and outputs the secret data as encoded data to the second arithmetic module 11 (block ST9). The second arithmetic module 11 decodes the encoded data by the preset second apparatus unique value, and outputs the decoded result as decoded data (block ST10).

On the other hand, in the case where first power-on is executed (block ST1), the SoC 7 outputs the apparatus unique value to the encoding module 1 (block ST11), and starts, as a first power-on process, a process of setting the apparatus unique value (block STA). Even if the power-on is not the first power-on, if it is determined that the cancel signal has been transmitted (block ST2), the SoC 7 deletes the first apparatus unique value setting-completion signal and second apparatus unique value setting-completion signal, which are held, and cancels the setting of the first apparatus unique value and second apparatus unique value (block ST12), and the first power-on process (block STA) is started.

In the case where the first power-on process is started by the cancel signal, the setting of the apparatus unique value may be executed on the basis of the apparatus unique value which has already been sent to the encoding module 1, or the apparatus unique value may be sent once again from the SoC 7 to the encoding module 1. If the first power-on process is completed, the processing of the secret data is performed in the same manner as in the case where second or subsequent power-on is executed (block ST3 to block ST10).

In the first power-on process, to start with, the first code generator 3 sets the apparatus unique value, which is output from the SoC 7, as the first apparatus unique value, and outputs the first apparatus unique value to the data transposing circuit 4 (block STA1). In addition, it is determined whether the first apparatus unique value has been set (block STA1). If the first apparatus unique value has been set, the first apparatus unique value setting-completion signal is output (block STA2).

The data transposing circuit 4 subjects the first apparatus unique value to the transposing process (block STA3), and outputs the transposed data, which is produced by the transposing process, and the sync signal to the transmission module 6 (block STA4). The transmission module 6 mixes the transposed data and the sync signal, and outputs the resultant data as initialized data to the decoding module 2 (block STA5).

The reception module 10 separates the received initialized data into the sync pulse and re-transposition data, and outputs the sync pulse and re-transposition data to the data re-transposing circuit 8 (block STA6). The data re-transposing circuit 8 re-transposes the transposed data by using the sync pulse, thereby reproducing the first apparatus unique value and outputting the first apparatus unique value to the second code generator 9 (block STA7). The second code generator 9 sets the received first apparatus unique value as the second apparatus unique value, and determines whether the second apparatus unique value has been set or not (block STA8). After the second apparatus unique value is set, the second code generator 9 outputs the second apparatus unique value setting-completion signal.

As has been described above, in the signal processing method according to the present embodiment, the setting of the apparatus unique value is executed only when the first power-on is executed, and the data encoding and decoding are executed by using the apparatus unique value. Specifically, the module for encoding the data by the apparatus unique value is provided in the signal processing path for decoding, reproducing and recording the data that is protected by the protection standard. Thereby, the robustness of data can be enhanced.

According to the signal processing apparatus and signal processing method of the present embodiment, since the module for monitoring the apparatus unique value setting signal is provided, the security of secret data of the apparatus against tapping or tampering can be enhanced.

When the data that is protected by the protection standard is decoded, reproduced and recorded, data, other than non-compressed and non-encrypted data, can easily made secret in the signal processing path for decoding, reproducing and recording the data that is protected by the protection standard. Besides, while the data is being protected, the degree of freedom of the system configuration can be increased.

The process for sharing the apparatus unique value, which is used in encoding, between the encoding module and the decoding module is executed only at the time of first power-on. When the process is executed once again, the cancel signal is input from the outside. Therefore, the strength of protection against tapping, etc. can be increased.

The apparatus unique value is encoded with a cycle which corresponds to an integer-number of times of the frequency of the data. Therefore, the frequency spectrum can be spread, and the amount of unwanted radiation can be decreased.

According to the signal processing apparatus, signal processing method and video reproducing apparatus, which relate to the embodiment of the invention, when the data that is protected by the protection standard is decoded, reproduced and recorded, data, other than non-compressed and non-encrypted data, can easily made secret in the signal processing path for decoding, reproducing and recording the data that is protected by the protection standard, and, while the data is being protected, the degree of freedom of the system configuration can be increased.

The present invention is not limited directly to the above-described embodiment. In practice, the structural elements can be modified and embodied without departing from the spirit of the invention. In the signal processing apparatus, signal processing method and video reproducing apparatus according to the above-described embodiment, shift registers are used as the shift register module 3C and shift register module 9C in the first code generator 3 and second code generator 9. Alternatively, in order to enhance the security of confidentiality, cyclic encoders may be used.

In the data transposing circuit 4, the sequence of the first apparatus unique value is transposed by reversing the bit sequence. However, other methods may be adopted if the algorithm is shared between the encoding module 1 and the decoding module 2. In order to enhance the security, use may be made of a well-known method such as a Fibonacci sequence, or this kind of sequence conversion method.

In the signal processing apparatus and signal processing method according to the above-described embodiment, the processing path for sharing the apparatus unique value between the encoding module 1 and decoding module 2 is separated from the processing path for the secret data. However, the same transmission path may be used therefor.

Furthermore, in the signal processing apparatus according to the above-described embodiment, the encoding module 1 may be incorporated in the SoC 7, and the decoding module 2 may be incorporated in the interface such as HDMI. The security of secret data can further be enhanced, if the transmission path between the encoding module 1 and SoC 7 and the transmission path between the decoding module 2 and HDMI are not exposed.

Various inventions can be made by properly combining the structural elements disclosed in the embodiment. For example, some structural elements may be omitted from all the structural elements disclosed in the embodiment. Furthermore, structural elements in different embodiments may properly be combined.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

The various modules of the systems described herein can be implemented as software applications, hardware and/or software modules or components on one or more computers, such as servers. While the various modules are illustrated separately, they may share some or all of the same underlying logic or code.

1. An information processing apparatus comprising an encoder, a decoder, and a controller configured to control the encoder and the decoder,
wherein the encoder comprises a first arithmetic module configured to encode data with a first eigenvalue, and a transmitter configured to transmit the encoded data,
the decoder comprises a receiver configured to receive the encoded data from the encoder, and a second arithmetic module configured to decode the encoded data with a second eigenvalue, and
the first eigenvalue and the second eigenvalue are the same.

2. The information processing apparatus of claim 1, wherein the controller comprises a power-up determination module configured to determine whether first power-up has been executed,
the encoder further comprises a first eigenvalue setting module configured to set an eigenvalue received from the controller, as the first eigenvalue when the first power-up is executed, and to transmit a first completion signal indicative of completion of the setting the first eigenvalue to the controller; and a transposing module configured to transpose an array of the first eigenvalue and to transmit the transposed array, and
the decoder further comprises a re-transposing module configured to reproduce the first eigenvalue by re-transposing the transposed data array; and a second eigenvalue setting module configured to set the first eigenvalue from the re-transposing module as the second eigenvalue, and to transmit a second completion signal indicative of completion of the setting of the second eigenvalue to the controller.

3. The information processing apparatus of claim 2, wherein the controller further comprises:
a cancellation signal detection module configured to detect a cancellation signal; and
a module configured to cancel the setting of the first eigenvalue and the second eigenvalue when the cancellation signal is detected, and configured to cause the first eigenvalue setting module and the second eigenvalue setting module to set the first eigenvalue and the second eigenvalue.

4. The information processing apparatus of claim 2, wherein the first eigenvalue is encoded with a cycle which is an integral multiple of a cycle of the data.

5. The information processing apparatus of claim 1, wherein the encoder further comprises a first sync pattern generator configured to generate a first sync pattern,
the first arithmetic module comprises a first sync pattern encoder configured to encode the first sync pattern with the first eigenvalue,
the second arithmetic module comprises a second sync pattern generator configured to generate a second sync pattern identical to the first sync pattern, and a phase determination module configured to decode the first sync pattern with the second eigenvalue, and to determine phases of the first sync pattern and the second sync pattern,
the phase determination module comprises a module configured to output a phase selection signal to the controller and the first arithmetic module after the determining the phases, and
the first arithmetic module comprises a switch configured to stop the encoding of the first sync pattern after receiving the phase selection signal, and to start encoding of the data.

6. The information processing apparatus of claim 2, wherein the transposing module comprises a sync signal generator configured to generate a sync signal in sync with the encoder, and
the transmitter comprises a mixer configured to mix the transposed data array from the transposing module and the sync signal, and to transmit the mixed data.

7. An information processing method comprising:
encoding data from a controller, in an encoder, and transmitting the encoded data; and
decoding the encoded data in a decoder,
wherein the encoding data comprises encoding the data with a first eigenvalue, and transmitting the encoded data, and
the decoding data comprises receiving the encoded data, and decoding the encoded data with a second eigenvalue which is the same value as the first eigenvalue.

8. The information processing method of claim 7, further comprising:
determining whether first power-up has been executed;
setting the first eigenvalue in the encoder; and
setting the second eigenvalue in the decoder when it is determined that the first power-up has been executed,
wherein the setting the first eigenvalue and setting the second eigenvalue comprises:
transmitting an eigenvalue from the controller to the encoder, and setting the eigenvalue as the first eigenvalue in the encoder;
transmitting a first eigenvalue setting-completion signal indicative of completion of setting the first eigenvalue from the encoder to the controller;
transposing an array of the first eigenvalue;
transmitting the transposed array to the decoder;
reproducing the first eigenvalue by re-transposing the transposed array;
setting the reproduced first eigenvalue as the second eigenvalue in the decoder; and
transmitting a second eigenvalue setting-completion signal indicative of completion of the setting of the second eigenvalue to the controller.

9. The information processing method of claim 8, further comprising:
detecting a cancellation signal;
canceling the setting of the first eigenvalue and the second eigenvalue when the cancellation signal is detected; and
starting the first power-up.

10. The information processing method of claim 7, further comprising:
generating a first sync pattern in the encoder;
encoding the first sync pattern with the first eigenvalue, and transmitting the encoded first sync pattern to the decoder;
generating a second sync pattern identical to the first sync pattern in the decoder;
decoding the first sync pattern with the second eigenvalue;
determining phases of the first sync pattern and the second sync pattern;
transmitting a phase selection signal to the controller and the encoder;
receiving the phase selection signal in the encoder;
stopping the encoding of the first sync pattern; and
starting encoding of the data.

11. The information processing method of claim 8, wherein the transmitting transposed array comprises:
generating a sync signal in sync with the encoding;
mixing the transposed array and the sync signal; and
transmitting the mixed data.

12. A reproducing apparatus comprising:
a receiver configured to selectively receive a signal;
a signal processor configured to process a signal from the receiver, with a predetermined procedure;
an encoder configured to encode the processed signal from the signal processor;
a decoder configured to decode the encoded signal from the encoder; and
a controller configured to control the encoder and the decoder,
wherein the encoder comprises a first setting module configured to set a first eigenvalue, a first arithmetic module configured to encode data with the first eigenvalue, and a transmitter configured to transmit the encoded data,
the decoding module comprises a second setting module configured to set a second eigenvalue, an encoded data receiver configured to receive the encoded data from the encoder, and a second arithmetic module configured to decode the encoded data with the second eigenvalue, and
the first eigenvalue and the second eigenvalue are the same.
